(19) United States
(12) Patent Application Publication
(10) Pub. No.: US 2024/0221313 A1
(43) Pub. Date: Jul. 4, 2024

(54) SYSTEM AND METHOD FOR PROVIDING VIRTUAL THREE-DIMENSIONAL MODEL

(71) Applicant: 3I INC., Daegu (KR)

(72) Inventors: Ken KIM, Seoul (KR); Ji Wuck JUNG, Goyang-si (KR); Farkhod Rustam Ugli KHUDAYBERGANOV, Seoul (KR); Mikhail LI, Paju-si (KR)

(73) Assignee: 3I INC., Daegu (KR)

(21) Appl. No.: 17/922,054

(22) PCT Filed: Jul. 20, 2022
(86) PCT No.: PCT/KR2022/010580

§ 371 Date: Oct. 28, 2022

(30) Foreign Application Priority Data
Dec. 31, 2021 (KR) 10-2021-0193635

(51) Int. Cl. G06T 17/20; G06T 7/20; G06T 7/70; H04N 23/695

(52) U.S. Cl. CPC G06T 17/20; G06T 7/20; G06T 7/70; H04N 23/695; G06T 2207/10024; G06T 2207/30201

(57) ABSTRACT

A system for providing a virtual three-dimensional (3D) model according to a technical aspect of the present application includes a user terminal and a server. The user terminal derives relative movement information from a previous capturing point to each of a plurality of capturing points in a real indoor environment to generate location information about the corresponding capturing point and generates a 360-degree color image and a 360-degree depth map image on the basis of the corresponding capturing point to generate a capture dataset of the corresponding capturing point. The server receives a plurality of capture datasets each corresponding to the plurality of capturing points in the real indoor environment from the user terminal, relates a 360-degree color image to a 360-degree depth map image generated at each of the plurality of capturing points in accordance with locations of unit pixels, and sets a distance value and a color value per unit pixel to generate point groups. The point groups are individually generated at the capturing points, and the server forms one integration point group by locationally relating the plurality of point groups individually generated at the plurality of capturing points to each other on the basis of the location information and generates a virtual 3D model on the basis of the integration point group.

### TECHNICAL FIELD

The present application relates to a system and method for providing a virtual three-dimensional (3D) model.

### BACKGROUND ART

Lately, virtual space implementation technology for providing an online virtual space corresponding to an actual space so that a user can experience the actual space without visiting the actual space in person has been under development.

A digital twin or metaverse is based on technologies for providing a virtual space on the basis of an actual space as described above.

To implement such a virtual space corresponding to an actual space, it is necessary to generate a virtual three-dimensional (3D) model which is a virtual image on the basis of image information and distance information of a real space to be implemented.

According to the related art, to generate such a 3D model, a 360-degree image captured at several capturing points in an indoor environment is acquired and used.

However, according to the related art, it is difficult to acquire location information about several capturing points in an indoor environment. Accordingly, a method of reversely calculating the locations of several capturing points on the basis of images captured at each of the capturing points, etc. is used, but a great deal of resources are required to determine an capturing point, and the processing is slow.

### DISCLOSURE

### Technical Problem

The present application is directed to providing a virtual three-dimensional (3D) space corresponding to an indoor environment on the basis of capture datasets collected from several capturing points in the indoor environment.

The present application is also directed to providing an environment in which a 360-degree rotatable and movable assistant cradle is used so that a virtual 3D model can be readily generated even using a general smart device such as a smartphone.

The present application is also directed to increasing accuracy of a virtual 3D model by efficiently and accurately calculating distance information between several capturing points in an indoor environment.

Objects of the present application are not limited to those described above, and other objects which have not been described will be clearly understood by those of ordinary skill in the art from the following description.

### Technical Solution

One aspect of the present application provides a system for providing a virtual three-dimensional (3D) model, the system including a user terminal and a server. The user terminal derives relative movement information from a previous capturing point to each of a plurality of capturing points in a real indoor environment to generate location information about the corresponding capturing point and generates a 360-degree color image and a 360-degree depth map image on the basis of the corresponding capturing point to generate an capture dataset of the corresponding capturing point. The server receives a plurality of capture datasets each corresponding to the plurality of capturing points in the real indoor environment from the user terminal, relates a 360-degree color image to a 360-degree depth map image generated at each of the plurality of capturing points in accordance with locations of unit pixels, and sets a distance value and a color value per unit pixel to generate point groups. The point groups are individually generated at the capturing points, and the server forms one integration point group by locationally relating the plurality of point groups individually generated at the plurality of capturing points to each other on the basis of the location information and generates a virtual 3D model on the basis of the integration point group.

Another aspect of the present application provides a method of generating a 3D model. The method of generating a 3D model is performed in a system including a user terminal and a server configured to provide a virtual 3D model corresponding to a real indoor environment in cooperation with the user terminal and includes generating, by the user terminal, a plurality of capture datasets, each of which includes a 360-degree color image generated on the basis of any one of a plurality of capturing points, a 360-degree depth map image generated on the basis of the capturing point, and location information derived from relative movement information from a previous capturing point to the capturing point, at the plurality of capturing points and providing the plurality of capture datasets to the server, relating, by the server, a 360-degree color image and a 360-degree depth map image generated at each of the plurality of capturing points to each other in accordance with locations of unit pixels and setting a distance value and a color value per unit pixel to generate point groups which are individually generated at the capturing points, and locationally relating, by the server, the plurality of point groups individually generated at the plurality of capturing points to each other on the basis of the location information to form one integration point group.

The above objects are not all features of the present application. Various means to achieve objects of the present application will be understood in further detail with reference to specific embodiments in the following detailed description.

### Advantageous Effects

The present application has the following one or more effects.

According to an embodiment disclosed in the present application, it is possible to accurately provide a virtual three-dimensional (3D) space corresponding to an indoor environment using capture datasets collected from several capturing points in the indoor environment.

According to an embodiment disclosed in the present application, it is possible to provide an environment in which a 360-degree rotatable and movable assistant cradle is used so that a virtual 3D model can be readily generated even using a general smart device such as a smartphone.

According to an embodiment disclosed in the present application, it is possible to increase accuracy of a virtual 3D model by efficiently and accurately calculating distance information between several capturing points in an indoor environment.

Effects of the present application are not limited to those described above, and other effects which have not been described will be clearly understood by those of ordinary skill in the art from the following descriptions.

### DESCRIPTION OF DRAWINGS

FIG. 1 is a diagram illustrating a system for providing a virtual three-dimensional (3D) model according to an embodiment disclosed in the present application.

FIG. 2 is a diagram showing an example of using a user terminal and a movable assistant device according to an embodiment disclosed in the present application.

FIG. 3 is a block diagram illustrating a movable assistant device according to an embodiment disclosed in the present application.

FIG. 4 is a block diagram illustrating a user terminal according to an embodiment disclosed in the present application.

FIG. 5 is a diagram illustrating an example of imaging at a plurality of capturing points in an indoor environment.

FIG. 6 is a flowchart illustrating an example of a control method performed by a user terminal according to an embodiment disclosed in the present application.

FIG. 7 is a flowchart illustrating another example of a control method performed by a user terminal according to an embodiment disclosed in the present application.

FIG. 8 is a block diagram illustrating a server according to an embodiment disclosed in the present application.

FIG. 9 is a flowchart illustrating an example of a control method performed by a server according to an embodiment disclosed in the present application.

FIG. 10 is a flowchart illustrating another example of a control method performed by a server according to an embodiment disclosed in the present application.

FIGS. 11 to 15 are diagrams illustrating a texturing method performed by a server according to an embodiment disclosed in the present application.

### MODES OF THE INVENTION

Hereinafter, exemplary embodiments of the present application will be described with reference to the accompanying drawings.

However, it should be understood that there is no intent to limit the scope of the present application to the specific embodiments, and the scope of the present application encompasses various modifications, equivalents, and/or alternatives of the embodiments of the present disclosure.

In describing the present disclosure, when detailed description of a related known function or element may unnecessarily obscure the gist of the present disclosure, the detailed description will be omitted.

Terminology used in the present disclosure is only for the purpose of describing the specific embodiments and is not intended to limit the scope of the present disclosure. A singular expression may include a plural expression unless they are clearly different in the context.

In the present disclosure, the expressions “have,” “may have,” “include,” and “may include” refer to the existence of a corresponding feature (e.g., a numeral, a function, an operation, or a component such as a part) and do not exclude the existence of additional features.

In describing the drawings, similar reference numerals may be used for similar or related components. A singular noun of an item may include one or a plurality of items unless the context clearly indicates otherwise. In the present application, each of the expressions “A or B,” “at least one of A and B,” “at least one of A or B,” “A, B, or C,” “at least one of A, B, and C,” and “at least one of A, B, or C” may include any or all possible combinations of the items listed therein.

The terms “first,” “second,” “primary,” or “secondary” may be used to distinguish a corresponding component from another corresponding component and do not limit the corresponding components in other aspects (e.g., importance or order).

When it is mentioned that a certain (e.g., first) component is “coupled” or “connected” to another (e.g., second) component with or without the term “functionally” or “communicatively,” it should be construed that the certain component is connected to the other component directly or via a third component.

The expression “configured (or set) to” used in the present disclosure may be interchangeably used with, for example, “suitable for,” “having the capacity to,” “designed to,” “adapted to,” “made to,” or “capable of” according to circumstances. The term “configured (or set) to” may not necessarily mean “specifically designed to” in hardware.

In embodiments, a “module” or “unit” may perform at least one function or operation and may be implemented with hardware, software, or a combination of hardware and software. Also, a plurality of “modules” or “units” may be integrated into at least one module as being implemented with at least one processor except for a “module” or “unit” which has to be implemented with specific hardware.

Various embodiments of the present application may be implemented as software (e.g., a program) including one or more instructions stored in a machine-readable storage medium. For example, a processor may call and execute at least one of the stored one or more instructions from the storage medium. This allows a device to perform at least one function in accordance with the called at least one instruction. The one or more instructions may include code generated by a compiler or code executable by an interpreter. The machine-readable storage medium may be provided in the form of a non-transitory storage medium. The term “non-transitory” only denotes that a storage medium is a tangible device and does not include a signal (e.g., radio waves). The term does not distinguish a case in which data is semi-permanently stored in a storage medium from a case in which data is temporarily stored in a storage medium.

Various flowcharts are disclosed to describe embodiments of the present application. The flowcharts are for the convenience of describing each step or operation, and steps are not necessarily performed in the order shown in the flowchart. In other words, steps in a flowchart may be performed concurrently, in the order shown in the flowchart, or in the reverse order to the order shown in the flowchart.

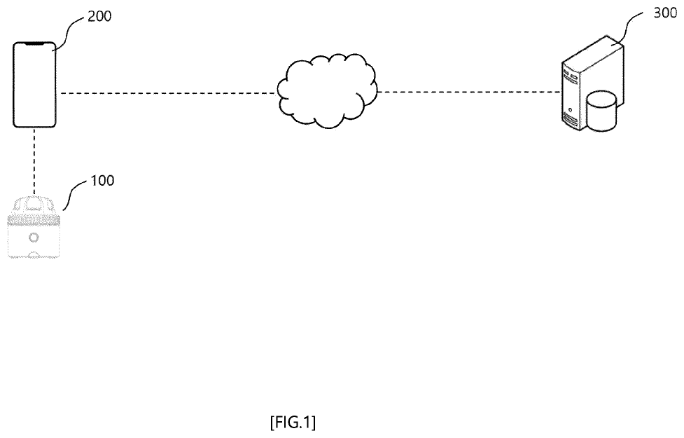

FIG. 1 is a diagram illustrating a system for providing a virtual three-dimensional (3D) model according to an embodiment disclosed in the present application.

The system for providing a virtual 3D model may include a user terminal 200, a movable imaging assistant device 100, and a server 300.

The user terminal 200 is an electronic device for generating an capture dataset at each capturing point in an indoor environment and is a portable electronic device including a camera and a distance measurement sensor.

For example, the user terminal 200 may be a smartphone, a tablet personal computer (PC), a laptop computer, a personal digital assistant (PDA), a portable multimedia player (PMP), or a wearable device such as a smartwatch, smart glasses, etc.

The user terminal 200 may generate a color image expressed in color. In the present application, color images include all images expressed in color and are not limited to a specific expression method. Accordingly, color images of various standards, such as a red green blue (RGB) image expressed in RGB, a cyan magenta yellow key (CMYK) image expressed in CMYK, etc., are applicable.

The user terminal 200 is a device that may generate a depth map image by generating depth information. In the present application, a depth map image is an image including depth information about a subject space. For example, each pixel in a depth map image may be distance information from an capturing point to each point of the imaged subject space which corresponds to a pixel.

The user terminal 200 may generate 360-degree color images and 360-degree depth map images at a plurality of capturing points which are present indoors. Also, the user terminal 200 may generate location information about each of the plurality of capturing points.

The user terminal 200 may individually generate capture datasets for the plurality of capturing points which are present indoors. The capture datasets may include a 360-degree color image, a 360-degree depth map image, and location information about the corresponding capturing point.

According to an embodiment, location information about each point may be based on relative location information generated on the basis of a previous point. Since it is difficult to calculate absolute location information, such as Global Positioning System (GPS) information, about an indoor environment, the user terminal 200 may generate relative movement information on the basis of video recognition and a change in inertial measurement data and set location information on the basis of the relative movement information.

According to an embodiment, the user terminal 200 may be fixed to the movable imaging assistant device 100, and 360-degree imaging may be enabled by controlling motion of the movable imaging assistant device 100. Since the user terminal 200 cannot rotate by itself, the system includes the movable imaging assistant device 100 that is driven in accordance with the control of the user terminal 200 so that the user terminal 200 can smoothly perform 360-degree imaging, that is, generation of a 360-degree color image and a 360-degree depth map image.

The server 300 may receive a plurality of capture datasets generated at several indoor capturing points. The server 300 may generate a virtual 3D model which is a virtual 3D space corresponding to an indoor environment using the plurality of capture datasets, that is, color images and depth map images generated at the several indoor points.

As an example, the server 300 may receive the plurality of capture datasets corresponding to the plurality of capturing points in the actual indoor environment, relate a 360-degree color image and a 360-degree depth map image generated at each of the plurality of capturing points to each other in accordance with the location of each unit pixel, and set a distance value and a color value per unit pixel to generate point groups. The point groups may be individually generated for capturing points. The server 300 may form one integration point group by locationally relating the plurality of point groups, which are individually generated for the plurality of capturing points, on the basis of location information. The server 300 may generate a virtual 3D model on the basis of the integration point group.

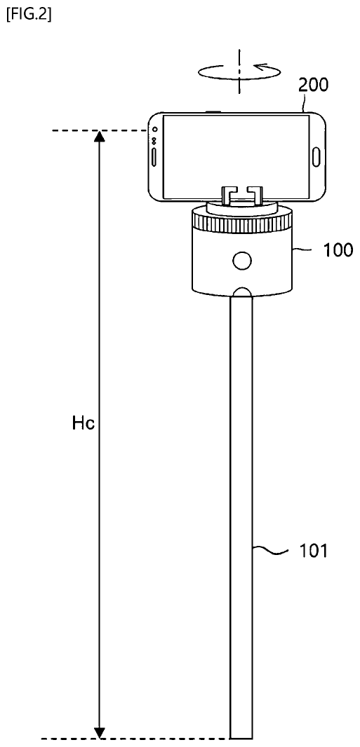

The server 300 may provide a virtual 3D space corresponding to the real space by providing the virtual 3D model to the user terminal 200 or another terminal. FIG. 2 is a diagram showing an example of using a user terminal and a movable assistant device according to an embodiment disclosed in the present application.

The user terminal 200 may be fixed on the movable assistant device 100, and the movable assistant device 100 allows a rotary unit on which the user terminal 200 is held to rotate so that the user terminal 200 can perform 360-degree imaging.

The movable assistant device 100 may employ a complementary height member such as a tripod 101. Information on an imaging height Hc of the camera which reflects the complementary height member may be input by a user or provided to the server 300 as a preset height which is set in advance using a standardized complementary height member.

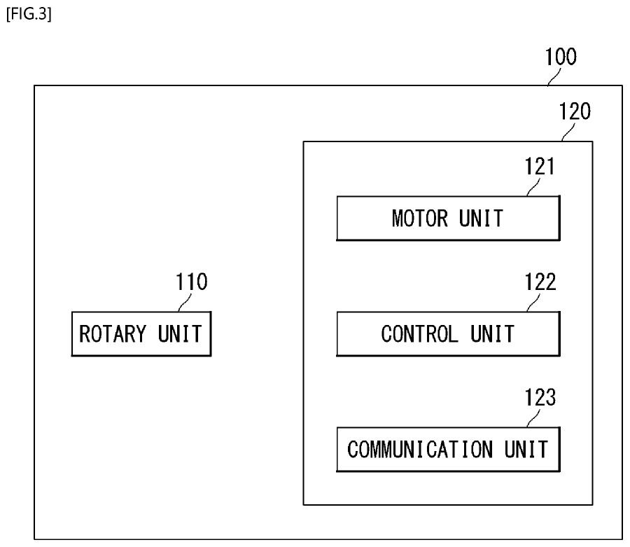

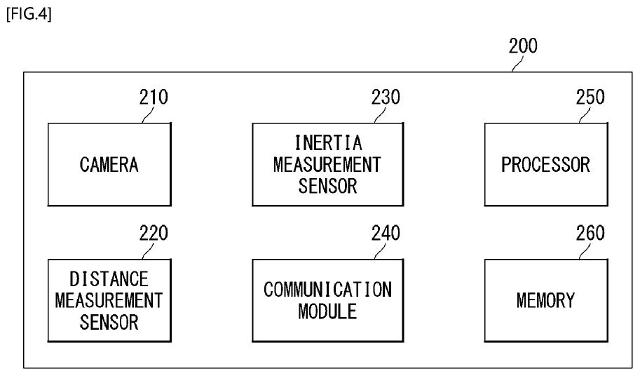

FIG. 3 is a block diagram illustrating a movable assistant device according to an embodiment disclosed in the present application.

The terminal cradle 100 may include a rotary unit 110 and a body unit 120.

The user terminal 200 may be held on the rotary unit 110 and rotated by an operation of a motor unit 121. The imaging direction of the user terminal 200 may be changed in accordance with rotation of the rotary unit 110. Also, the rotation direction and rotation speed of the rotary unit 110 may be changed in accordance with the operation of the motor unit 121.

As an example, the rotary unit 110 may include a fixture, a tightener, and a turntable. The fixture and tightener may be disposed on the turntable. The fixture and tightener may fix the user terminal 200. The turntable may rotate in accordance with operation of the motor unit 121, and to this end, the turntable may be mechanically coupled to the motor unit 121.

The body unit 120 may include the motor unit 121, a control unit 122, and a communication unit 123. The control unit 122 may control operations of the terminal cradle 100 by controlling the components of the body unit 120.

The communication unit 123 may establish a communication connection with the user terminal 200 and receive a control signal for moving the terminal cradle 100 from the user terminal 200. As an example, the communication unit 123 may establish the communication connection with the user terminal 200 using at least one of a short-range communication module and wired communication.

The control unit 122 may control an operation of the rotary unit 110 by driving the motor unit 121 in accordance with the control signal received through the communication unit 123.

FIG. 4 is a block diagram illustrating a user terminal according to an embodiment disclosed in the present application.

Referring to FIG. 4, the user terminal 200 includes a camera 210, a distance measurement sensor 220, an inertia measurement sensor 230, a communication module 240, a processor 250, and a memory 260.

Although not shown in the drawing, the configuration of the user terminal 200 is not limited to the foregoing components or the names of the components. For example, a battery and the like for supplying power to the user terminal 200 may also be included in the user terminal 200.

The user terminal 200 or the processor 250 executes an application and thus is expressed below as the subject of control, instructions, or functions. However, this denotes that the processor 250 executes instructions or applications stored in the memory 260 to operate.

The camera 210 may include at least one camera. The camera 210 may include one or more lenses, image sensors, image signal processors, or flashes. The camera 210 may capture a forward video of the user terminal 200. As an example, the imaging direction of the camera 210 may be rotated by rotary motion of the movable imaging assistant device 100, and thus 360-degree imaging is enabled. 360-degree imaging of the camera 210 may be implemented in various ways depending on embodiments. For example, an image may be captured at every certain angle, and the processor 250 may integrate the images into a 360-degree color image. According to an embodiment, for 360-degree imaging, forward images may be captured at every certain angle through 360-degree rotation and provided to the server 300, and the server 300 may integrate the forward images into a 360-degree color image.

The distance measurement sensor 220 may measure the distance from the user terminal 200 to a subject. As the distance measurement sensor 220, a Light Detection and Ranging (LiDAR) sensor, an infrared sensor, an ultrasonic sensor, etc. may be used.

According to an embodiment, the distance measurement sensor 220 may be implemented as a stereo camera, a stereoscopic camera, or a 3D depth camera which may measure distance information instead of the distance measurement sensor 220.

The measurement direction of the distance measurement sensor 220 may be rotated by rotary motion of the movable imaging assistant device 100, and 360-degree measurement is also enabled through the rotary motion. A depth map image may be generated on the basis of the measurement of the distance measurement sensor 220. The depth map image is an image including depth information about a subject space. For example, each pixel in the depth map image may be distance information from an capturing point to each point in the imaged subject space which corresponds to a pixel.

According to an embodiment, a 360-degree color image and a 360-degree depth map image may be panoramic images suitable for covering 360 degrees, for example, equirectangular panoramic images.

The inertia measurement sensor 230 may detect an inertial characteristic of the user terminal 200 and generate an electrical signal or a data value corresponding to the detected state.

As an example, the inertia measurement sensor 230 may include a gyro sensor and an acceleration sensor. Data measured by the inertia measurement sensor 230 is referred to as “inertia sensing data” below.

The communication module 240 may include one or more modules that allow communication between the user terminal 200 and the movable imaging assistant device 100 or between the user terminal 200 and the server 300. The communication module 240 may include at least one of a mobile communication module, a wireless Internet module, and a short-range communication module.

The processor 250 may control at least some of the components shown in FIG. 3 to run an application program, that is, an application, stored in the memory 260. Further, to run the application program, the processor 250 may operate at least two of the components included in a user terminal 200 in combination. The processor 250 may execute instructions stored in the memory 260 to run the application.

In addition to the operation related to the application program, the processor 250 generally controls overall operations of the user terminal 200. The processor 250 may provide appropriate information or an appropriate function to a user or process the appropriate information or function by processing a signal, data, information, etc. input or output through the above-described components or running the application program stored in the memory 260. The processor 250 may be implemented as one processor or a plurality of processors.

The processor 250 may generate relative location information about an indoor point at which an omnidirectional image has been acquired using a change of a forward video and a variation of the inertia sensing data. For example, the processor 250 may generate a relative location change from a previous capturing point to each of several capturing points in an indoor environment on the basis of a change of a forward video and a variation of the inertia sensing data from the previous capturing point to the corresponding capturing point and set the relative location change as relative movement information.

As an example, the processor 250 may extract at least one feature point from a forward video and generate visual movement information of the mobile terminal, which includes at least one of a moving direction and a moving distance, on the basis of a change in the extracted at least one feature point.

As an example, the processor 250 may generate inertial movement information of the mobile terminal, which includes at least one of the moving direction and the moving distance, using the variation of the inertia sensing data and verify the visual movement information on the basis of the inertial movement information to generate the relative movement information.

As an example, when the visual movement information includes abnormal value data exceeding a preset threshold which includes at least one of a redirection threshold and a moving distance threshold, the processor 250 may compare the data of inertial movement information corresponding to the abnormal value data of the visual movement information with the abnormal value data to determine whether to apply the abnormal value data.

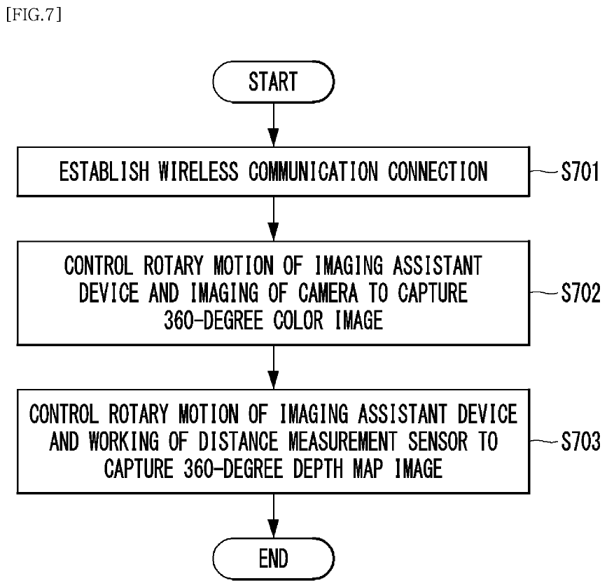

The processor 250 may control motion of the movable imaging assistant device 100 so that the rotary unit of the movable imaging assistant device 100 rotates 360 degrees. This will be further described with reference to FIG. 7, which is a flowchart illustrating an example of a control method performed by a user terminal. The processor 250 may establish a communication connection, for example, short-range wireless communication, with the movable imaging assistant device 100 by controlling the communication module 240 (S701). To capture a 360-degree color image, the processor 250 may allow 360-degree imaging by controlling rotary motion of the imaging assistant device and imaging of the camera (S702). Also, to capture a 360-degree depth map image, the processor 250 may allow 360-degree imaging by controlling rotary motion of the imaging assistant device and working of the distance measurement sensor 220 (S703).

The processor 250 may generate a 360-degree color image on the basis of an image captured by the camera 210 and generate a 360-degree depth map image on the basis of measurement data of the distance measurement sensor 220. Such a 360-degree color image or a 360-degree depth map image may also be generated by the server 300.

According to an embodiment, the processor 250 may perform 360-degree imaging by controlling imaging of the camera during a first rotation of the movable imaging assistant device 100 and perform 360-degree sensing by controlling sensing of the distance measurement sensor 220 during a second rotation. For example, the processor 250 may generate a 360-degree color image at any one capturing point by controlling motion of the movable imaging assistant device 100 at the capturing point in the indoor environment so that the imaging direction of the user terminal rotates 360 degrees a first time. The processor 250 may generate a 360-degree depth map image at any one capturing point by controlling motion of the movable imaging assistant device 100 so that the imaging direction of the user terminal rotates 360 degrees a second time.

With respect to each point in the indoor environment, the processor 250 may store relative distance information, a 360-degree color image or a plurality of color images for generating the 360-degree color image, and a 360-degree depth map image or a plurality of depth map images for generating the 360-degree depth map image as one dataset, that is, an capture dataset, and provide the capture dataset to the server 300.

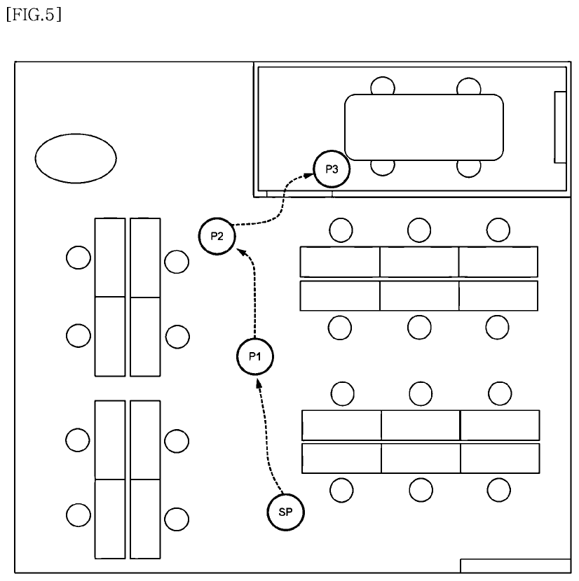

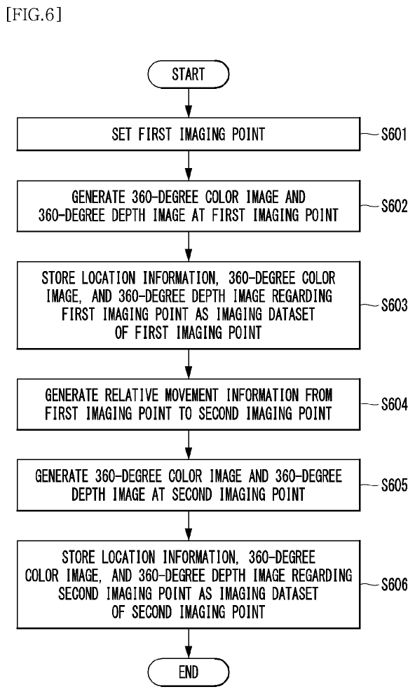

FIG. 5 is a diagram illustrating an example of imaging at a plurality of capturing points in an indoor environment, and FIG. 6 is a flowchart illustrating an example of a control method performed by a user terminal according to an embodiment disclosed in the present application.

A method of generating an capture dataset by a user terminal will be described with reference to FIGS. 5 and 6.

In the indoor environment of FIG. 5, imaging is performed four times in total, and movement between capturing points may be performed by a user.

Referring to FIG. 6, the user may perform 360-degree imaging at a start capturing point SP. For example, the user may set the start capturing point SP in a plan view displayed in the user terminal 200 (S601).

The user may input an imaging instruction through software installed on the user terminal 200, and the user terminal 200 may perform 360-degree imaging and sensing by controlling motion of the movable imaging assistant device 100 (S602).

The user terminal 200 may generate an capture dataset corresponding to the start capturing point SP including location information about the set start capturing point SP and a 360-degree color image and a 360-degree depth image captured at the location (S603).

Subsequently, the user may move from the start capturing point SP to a first capturing point P1, and during the movement, the camera 210 of the user terminal 200 may capture an on-the-go video. The user terminal 200 may generate a relative location change from the start capturing point SP to the first capturing point P1 on the basis of a video change of the on-the-go video and a variation of inertia sensing data and set the relative location change as relative movement information (S604).

The user performs 360-degree imaging and sensing at the first capturing point P1 to generate a 360-degree color image and a 360-degree depth image for the first capturing point SP1 (S605).

The user terminal 200 may generate an capture dataset of the first capturing point P1 including the generated 360-degree color image and 360-degree depth image and the relative location information (S606).

Such a process is continuously performed at a second capturing point and a third capturing point, and generation of all capture datasets may be finished at a point at which the end of imaging is set by the user, that is, the third capturing point in the example shown in the drawing. The user terminal 200 may transmit all generated capture datasets to the server 300.

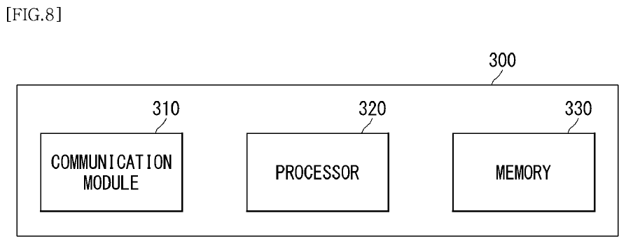

Various embodiments of the server 300 will be described below with reference to FIGS. 8 to 15.

FIG. 8 is a block diagram illustrating a server according to an embodiment disclosed in the present application. Referring to FIG. 8, the server 300 may include a communication module 310, a memory 330, and a processor 320.

However, the configuration is exemplary, and in implementing the present disclosure, a new component may be added to the configuration, or some components may be omitted.

The communication module 310 may perform communication with the user terminal 200. For example, the processor 320 may receive various data or information from the user terminal 200 connected through the communication module 310 or transmit various data or information to an external device. Various communication modules are applicable as the communication module 310, and the communication module 310 may support wired communication or wireless communication.

In the memory 330, at least one instruction for the electronic device 300 may be stored. In the memory 330, an operating system (OS) for operating the electronic device 300 may be stored. Also, various software programs or applications for the server 300 to operate in accordance with various embodiments of the present disclosure may be stored in the memory 330. The memory 330 may include a semiconductor memory, such as a flash memory, a magnetic storage medium such as a hard disk, etc.

Specifically, various software modules for the server 300 to operate in accordance with various embodiments of the present disclosure may be stored in the memory 330, and the processor 320 may control operations of the server 300 by executing the various software modules stored in the memory 330. In other words, the memory 330 may be accessed by the processor 320, and data reading, recording, modification, deletion, updating, etc. may be performed by the processor 320.

In addition, various information may be stored in the memory 330 within a range required for achieving objects of the present disclosure, and information stored in the memory 330 may be received from the external device or updated by an input of a user.

The processor 320 controls overall operations of the electronic device 300. Specifically, the processor 320 may be electrically connected to other components of the electronic device 300 including the communication module 310 and the memory 330 described above and may control overall operations of the server 300 by executing the at least one instruction stored in the memory 330.

The processor 320 may be implemented in various forms. For example, the processor 320 may be implemented as at least one of an application-specific integrated circuit (ASIC), an embedded processor, a microprocessor, hardware control logic, a hardware finite state machine (FSM), and a digital signal processor (DSP). Meanwhile, in the present disclosure, the meaning of the term “processor 320” may include a central processing unit (CPU), a graphic processing unit (GPU), a main processing unit (MPU), etc.

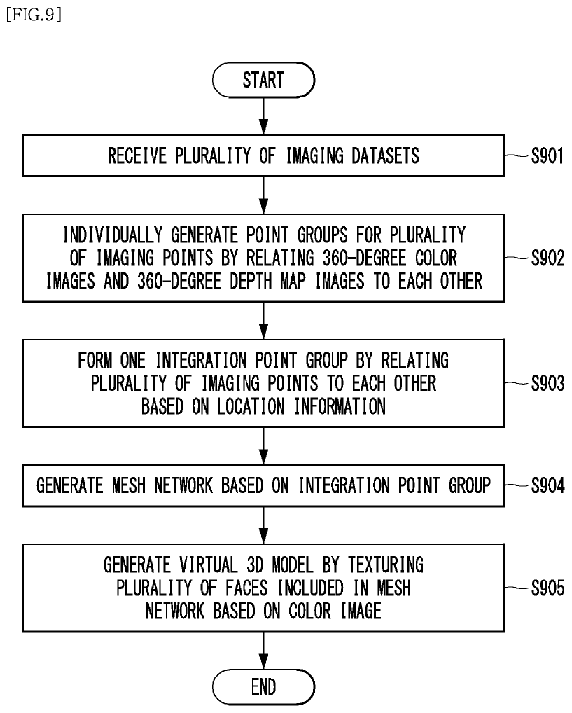

FIG. 9 is a flowchart illustrating an example of a control method performed by a server according to an embodiment disclosed in the present application. An operation of the processor 320 generating a virtual 3D model will be described with reference to FIG. 9.

The processor 320 may receive a plurality of capture datasets each corresponding to a plurality of capturing points in a real indoor environment from the user terminal 200 (S901).

The processor 320 may relate a 360-degree color image and a 360-degree depth map image generated at each of the plurality of capturing points to each other in accordance with the location of each unit pixel and set a distance value and a color value per unit pixel to generate point groups (S902).

The point groups may be individually generated at the capturing points.

For example, the plurality of point groups may be individually generated at the capturing points on the basis of independent coordinate systems. In other words, the processor 320 may generate points each having a distance value and a color value by relating a 360-degree color image and a 360-degree depth map image generated at each capturing point to each other in accordance with the location of each unit pixel and may generate a point group. One point group is individually generated per capturing point and may be generated on the basis of an absolute 3D coordinate system in which the location of the camera is on one axis.

The processor 320 may form one integration point group by reflecting the locations of the plurality of point groups each generated on the basis of independent coordinate systems in one coordinate system. For example, the processor 320 may form an integration point group by arranging the locations in one integrative absolute coordinate system on the basis of the location information, that is, relative location information, of each of the plurality of point groups each generated on the basis of independent coordinate systems (S903).

In the example of FIG. 5, the start capturing point SP may be set as a base location of the integrative absolute coordinate system, for example, an integration 3-axis coordinate system, and the absolute coordinate location of the first capturing point P1 may be set in the integration 3-axis coordinate system by reflecting relative distance information from the start capturing point SP to the first capturing point P1. As an example, the relative distance information may be used for setting a location in the horizontal plane (e.g., the X-Y plane) of the absolute coordinate system, and all height information (e.g., Z-axis values) may be set to the same value of the camera height Hc.

The processor 320 may generate a virtual 3D model on the basis of the integration point group. For example, the processor 320 may generate a mesh network on the basis of the integration point group (S904).

The mesh network is set on the basis of the integration point group and may be generated by sectioning the integration point group into unit spaces, generating one mesh point per unit space, and connecting adjacent mesh points to each other. As an example, a mesh point may be set as any one point which represents a unit space, for example, a point closest to the average of the unit space, in the unit space. As another example, average values, for example, a location value and a color value, of a plurality of points present in a unit space may be calculated and set for a mesh point.

The processor 320 may set multiple faces having a plurality of mesh points as vertices on the basis of the generated mesh network to generate a 3D mesh model. For example, a plurality of triangular faces may be generated by connecting three adjacent mesh points so that a 3D mesh model may be generated.

The processor 320 may texture the generated mesh network, that is, each of the plurality of faces included in the 3D mesh model, using the 360-degree color image to generate a virtual 3D model (S905).

When such texturing is performed, an area present at a blind spot of the camera may not be textured. In this case, a face which is not textured remains as a hole, and the processor 320 may perform a process of filling such a hole. For example, the processor 320 may set a color of at least one face, which does not correspond to a 360-degree color image and thus remains as a hole, among the plurality of faces included in the 3D mesh model on the basis of a point color of the point group.

Since points included in a point group have color values on the basis of a 360-degree color image as described above, such color values may be used for setting a color of a face. For example, a color of a mesh point may be determined on the basis of points in a point group, and a face expressed as a hole has a plurality of vertex mesh points constituting the face. Accordingly, a color of a face may be determined by extending colors of the plurality of vertex mesh points of the hole face, for example, in the case of a triangular face, by extending a color of each vertex to the face. Such color extension may involve changing different colors of two points to be an intermediate color by gradation between the two points and the like.

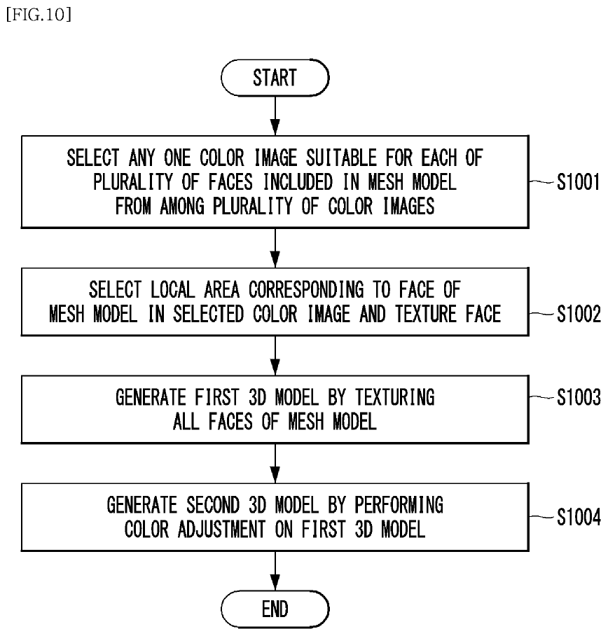

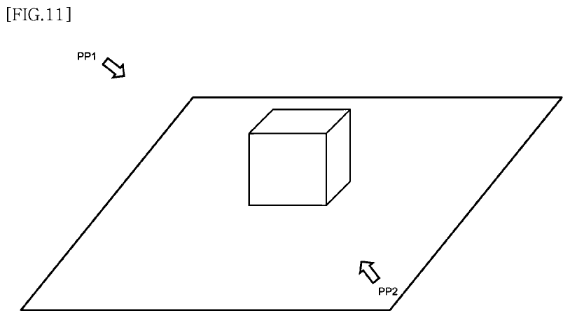

FIG. 10 is a flowchart illustrating another example of a control method performed by a server according to an embodiment disclosed in the present application. FIG. 10 illustrates an embodiment of a texturing method performed by a server and will be described below with reference to the example of FIGS. 11 to 15.

The processor 320 may select a first face which is any one of the plurality of faces included in the 3D mesh model and select any one first color image suitable for the first face from among a plurality of 360-degree color images (hereinafter, collectively referred to as “color images”) related to the first face (S1001).

In selecting the color image related to the first face, the processor 320 may calculate a unit vector perpendicular to the first face and select at least one color image having an imaging angle corresponding to the unit vector on the basis of the calculation as a color image related to the corresponding face. When a color image is captured, information on the imaging angle of the color image is generated together. Accordingly, the color image related to the first face, that is, a color image in which the first face is taken, may be selected on the basis of imaging height and imaging angle information of color images. For example, as the color image related to the corresponding face, the processor 320 may select a color image which faces the unit vector perpendicular to the first face within a certain angle, that is, the color image having an imaging angle at which the color image and the unit vector face each other within the certain angle.

Among color images related to a face, the processor 320 may select any one color image suitable for the face. For example, the processor 320 may calculate a plurality of weight elements for each of the related color images, calculate a weight on the basis of the weight elements, and then select any one color image on the basis of the weight.

As an example, a first color image matching the first face may be selected by evaluating the plurality of color images related to the 3D mesh model on the basis of an imaging direction with respect to the first face, a resolution, and color noise.

The processor 320 may select a local area corresponding to the first face in the selected color image, map the local area to the first face, and perform texturing (S1002).

Since the processor 320 has information on the imaging location of each color image, it is possible to project and map each object in each color image and each object in the 3D mesh model to each other. Accordingly, a local area corresponding to the face in a two-dimensional (2D) color image may be selected on the basis of such projective mapping of the 2D color image and the 3D mesh model.

The processor 320 may repeat the above-described operations S1001 and S1002 for all the faces of the 3D mesh model, generate color information of each face, and perform texturing (S1003). In the generated 3D model, color correction has not been performed between color images, and thus even the same surface may be stained. This is because imaging environments at indoor capturing points are different as described above.

The processor 320 may perform color adjustment to correct color difference caused by such imaging environments at indoor capturing points (S1004).

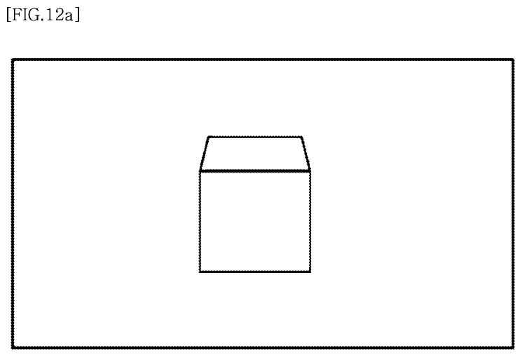

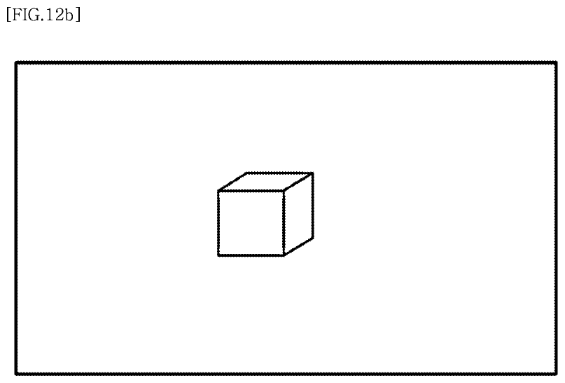

FIG. 11 is a perspective view showing a hexahedral subject as an example in an indoor environment and a first capturing point PP1 and a second capturing point PP2 for the hexahedral subject. FIG. 12A shows an example of a color image captured at the first capturing point PP1, and FIG. 12B shows an example of a color image captured at the second capturing point PP2.

FIGS. 12A and 12B show the same subject, but FIG. 12B shows an example in which a color is changed by the shadow.

The processor 320 may set a reference vector for the first face of the 3D mesh model, that is, a first direction vector Vfc1 perpendicular to the first face.

The processor 320 may calculate a first weight element having a directional relationship with the first direction vector with respect to each of a plurality of color images related to the first face.

The processor 320 may check the imaging directions of the plurality of color images related to the first face and calculate first weight elements on the basis of directional relationships between the first direction vector of the first face and the imaging directions. For example, a higher weight element may be calculated with a smaller angle between the first direction vector of the first face and an imaging direction.

The processor 320 may calculate a second weight element relating to resolution with respect to each of the plurality of color images related to the first face.

As an example, the processor 320 may check resolutions of the plurality of color images and calculate second weight elements on the basis of the resolutions. In other words, a higher second weight element may be calculated with higher resolution.

As another example, the processor 320 may identify an object to be textured or a face which is a part of the object and calculate a second weight element on the basis of the resolution of the identified object or face. Since the resolution of the object or face is set in inverse proportion to the distance between an capturing point and the object, a high second weight is given to a color image which is advantageous in terms of distance.

The processor 320 may calculate a third weight element relating to color noise with respect to each of the plurality of color images related to the first face.

The processor 320 may calculate color noise for each color image. To calculate color noise, various methodologies, such as unsupervised learning employing a deep convolutional generative adversarial network (DCGAN), a method employing an enlighten generative adversarial network (GAN), etc., may be used.

The processor 320 may give a higher third weight element with less color noise.

The processor 320 may calculate a weight for each of the plurality of color images by reflecting the first to third weight elements. The processor 320 may select one color image having the highest weight as a first image mapped to the first face.

Various algorithms are applicable to reflection of the first to third weight elements. For example, the processor 320 may calculate the weight in various ways such as simply adding the first to third weight elements, averaging the first to third weight elements, etc.

In the above-described example, all of the first to third weight elements are reflected, but the present disclosure is not limited thereto. Accordingly, the weight may be calculated in modified ways such as on the basis of the first and second weight elements, on the basis of the first and third weight elements, etc. Even in the modifications, including the first weight element is a factor of higher performance.

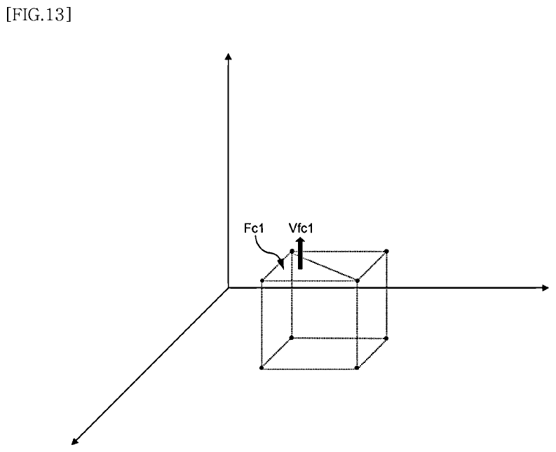

FIG. 13 shows an example of setting a first direction vector perpendicular to a first face Fc1 of a hexahedron. Referring to the example shown in FIGS. 13 and 11, the first capturing point PP1 has a higher first weight than the second capturing point PP2.

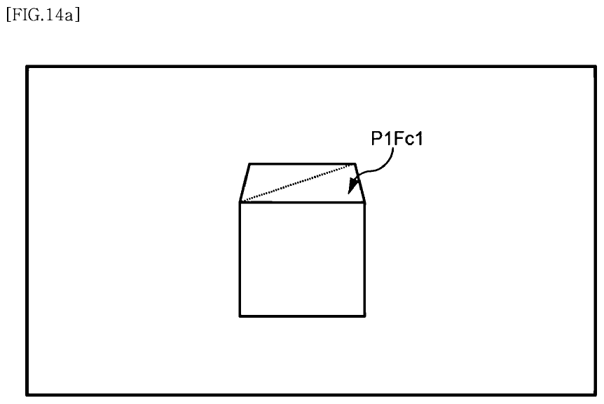

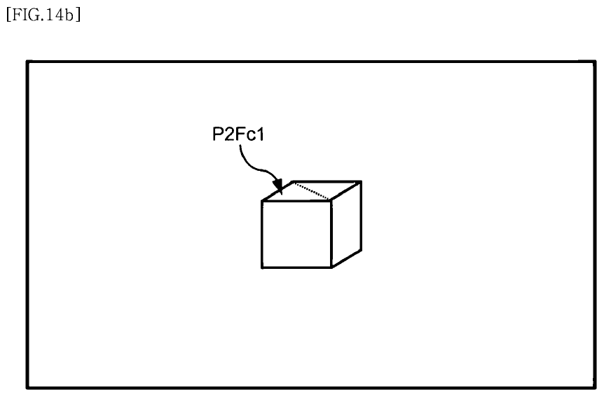

FIG. 14A illustrates a local area P1Fc1 corresponding to the first face in the color image captured at the first capturing point PP1, and FIG. 14B illustrates a local area P2Fc1 corresponding to the first face in the color image captured at the second capturing point PP2.

The color image captured at the first capturing point PP1 and shown in FIG. 14A has higher resolution than the color image captured at the second capturing point PP2 and shown in FIG. 14B and thus has a higher second weight element. Such resolution may be set on the basis of the size of the corresponding face.

Since color noise is set higher in the color image captured at the second capturing point PP2 and shown in FIG. 14B, the first capturing point PP1 shown in FIG. 14A has a higher third weight element.

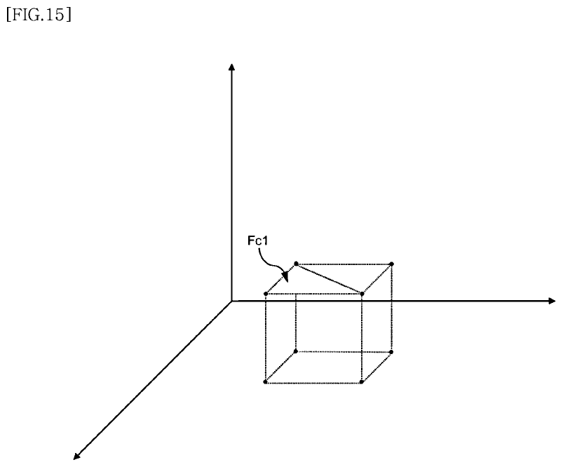

Therefore, the color image captured at the first capturing point PP1 is selected with respect to the first face, and the local area P1Fc1 in the color image captured at the first capturing point PP1 is matched to the first face to texture the first face, which is shown in FIG. 15.

The present application is limited by the following claims rather than the above-described embodiments and the accompanying drawings. Those skilled in the technical field to which the present application pertains should appreciate that the configuration of the present application can be variously modified and altered without departing from the technical spirit of the present application.

### INDUSTRIAL APPLICABILITY

The present invention relates to a virtual three-dimensional (3D) model provision system including a user terminal and a server. The virtual 3D model provision system has high industrial applicability because it can accurately provide a virtual 3D space corresponding to an indoor environment using capture datasets collected from several capturing points in the indoor environment, provide an environment in which a virtual 3D model can be readily generated even using a general smart device, such as a smartphone, by employing a 360-degree rotatable and movable assistant cradle, and increase accuracy of a virtual 3D model by efficiently and accurately calculating distance information between several capturing points in an indoor environment.

1. A system for providing a virtual three-dimensional (3D) model, the system comprising:
a user terminal configured to generate location information about a corresponding capturing point by deriving relative movement information from a previous capturing point to each of a plurality of capturing points in a real indoor environment and generate an capture dataset of the corresponding capturing point by generating a 360-degree color image and a 360-degree depth map image on the basis of the corresponding capturing point; and
a server configured to receive a plurality of capture datasets each corresponding to the plurality of capturing points in the real indoor environment from the user terminal, set a distance value and a color value per unit pixel by relating a 360-degree color image to a 360-degree depth map image generated at each of the plurality of capturing points in accordance with locations of unit pixels, and generate point groups,
wherein the point groups are individually generated at the capturing points, and
the server forms one integration point group by locationally relating the plurality of point groups individually generated at the plurality of capturing points to each other on the basis of the location information and generates a virtual 3D model on the basis of the integration point group.

2. The system of claim 1, further comprising a movable imaging assistant device configured to hold the user terminal and rotate an imaging direction of the user terminal 360 degrees by operating in accordance with control of the user terminal.

3. The system of claim 2, wherein the user terminal controls motion of the movable imaging assistant device at any one capturing point to rotate the imaging direction of the user terminal 360 degrees a first time and generates a 360-degree color image at the capturing point, and
controls motion of the movable imaging assistant device to rotate the imaging direction of the user terminal 360 degrees a second time and generates a 360-degree depth map image at the capturing point.

4. The system of claim 2, wherein the user terminal generates a relative location change from the previous capturing point to the corresponding capturing point on the basis of a change of a forward video and a variation of inertia sensing data from the previous capturing point to the corresponding capturing point and sets the relative location change as the relative movement information.

5. The system of claim 1, wherein the plurality of point groups are individually generated at the capturing points on the basis of independent coordinate systems, and
the server forms an integration point group by arranging the plurality of point groups generated on the basis of the independent coordinate systems in one integrative absolute coordinate system on the basis of the location information.

6. The system of claim 1, wherein the server generates a 3D mesh model on the basis of the integration point group and generates the virtual 3D model by texturing each of a plurality of faces included in the generated 3D mesh model using a 360-degree color image.

7. The system of claim 6, wherein the server sets a color of at least one face, which does not correspond to a 360-degree color image and remains as a hole, among the plurality of faces included in the 3D mesh model on the basis of a point color of the point group.

8. A method of generating a three-dimensional (3D) model performed in a system including a user terminal and a server configured to provide a virtual 3D model corresponding to a real indoor environment in cooperation with the user terminal, the method comprising:
generating, by the user terminal, a plurality of capture datasets, each of which includes a 360-degree color image generated on the basis of any one of a plurality of capturing points, a 360-degree depth map image generated on the basis of the capturing point, and location information derived from relative movement information from a previous capturing point to the capturing point, at the plurality of capturing points and providing the plurality of capture datasets to the server;
relating, by the server, a 360-degree color image and a 360-degree depth map image generated at each of the plurality of capturing points to each other in accordance with locations of unit pixels and setting a distance value and a color value per unit pixel to generate point groups which are individually generated at the capturing points; and
locationally relating, by the server, the plurality of point groups individually generated at the plurality of capturing points to each other on the basis of the location information to form one integration point group.

9. The method of claim 8, wherein the system further includes a movable imaging assistant device configured to hold the user terminal and rotate an imaging direction of the user terminal 360 degrees by operating in accordance with control of the user terminal.

10. The method of claim 9, wherein the generating of the plurality of capture data sets at the plurality of capturing points in the real indoor environment and the providing of the plurality of capture datasets to the server comprise:
controlling, by the user terminal, motion of the movable imaging assistant device at any one capturing point to rotate the imaging direction of the user terminal 360 degrees a first time and generating a 360-degree color image at the capturing point; and
controlling, by the user terminal, motion of the movable imaging assistant device to rotate the imaging direction of the user terminal 360 degrees a second time and generating a 360-degree depth map image at the capturing point.

11. The method of claim 10, wherein the generating of the plurality of capture data sets at the plurality of capturing points in the real indoor environment and the providing of the plurality of capture datasets to the server further comprise generating a relative location change from the previous capturing point to the corresponding capturing point on the basis of a change of a forward video and a variation of inertia sensing data from the previous capturing point to the corresponding capturing point and setting the relative location change as the relative movement information.

12. The method of claim 8, wherein the plurality of point groups are individually generated at the capturing points on the basis of independent coordinate systems, and
the server forms an integration point group by arranging the plurality of point groups generated on the basis of the independent coordinate systems in one integrative absolute coordinate system on the basis of the location information.

13. The method of claim 8, further comprising generating, by the server, a 3D mesh model on the basis of the integration point group and texturing each of a plurality of faces included in the generated 3D mesh model using a 360-degree color image to generate the virtual 3D model.

14. The method of claim 13, further comprising setting, by the server, a color of at least one face, which does not correspond to a 360-degree color image and remains as a hole, among the plurality of faces included in the 3D mesh model on the basis of a point color of the point group.
